(19) United States
(12) Patent Application Publication
(10) Pub. No.: US 2016/0232535 A1
(43) Pub. Date: Aug. 11, 2016

(54) MIGRATING PRESCRIPTIVE CONTENT

(71) Applicant: International Business Machines Corporation, Armonk, NY (US)

(72) Inventors: James E. Bostick, Austin, TX (US); Hernan A. Cunico, Holly Springs, NC (US); John M. Ganci, JR., Cary, NC (US); Martin G. Keen, Cary, NC (US)

(73) Assignee: International Business Machines Corporation, Armonk, NY (US)

(21) Appl. No.: 14/619,262

(22) Filed: Feb. 11, 2015

(51) Int. Cl. G06Q 30/00; G06F 17/30; G06F 17/28; G06F 17/24

(52) U.S. Cl. CPC G06Q 30/016; G06F 17/24; G06F 17/30011; G06F 17/28

(57) ABSTRACT

A method for logical migrating prescriptive content creates using a natural language processing (NLP) engine, a first set of action objects from a first prescriptive document. The method creates, using the NLP engine, a second set of actions from a product documentation. The method maps, in a document, a first action object from the first set of action objects to a second action object from the second set of action objects. the mapping substitutes a first action of the first action object with a second action of the second action object, replaces a property of the first action with a property of the second action, and populates the property of the second action with a value of the property of the first action.

### TECHNICAL FIELD

The present invention relates generally to a method, system, and computer program product for managing documentation in data processing environments. More particularly, the present invention relates to a method, system, and computer program product for migrating prescriptive content.

### BACKGROUND

A data processing environment has hardware, software, of firmware products (collectively hereinafter, “product”) installed therein. It is useful to guide users in using the products installed in a data processing environment. To this end, and apart from the documentation supplied by the product manufacturer, a user of a product also often has available one or more prescriptive documents.

Product documentation includes one or more documents supplied with the product as a part of the product package by a manufacturer of the product. Product documentation often takes one or more of the following forms—documents in paper or book form accompanying the product, files on a data storage medium such as a compact disk or a thumb drive, information on a website or remote storage referenced by a sticker or a leaflet accompanying the product.

A prescriptive document is data or content that provides step by step instructions to perform a function by operating a configuration of a product. For example, a database software product comes with the product documentation from the database manufacturer. But, when the database is installed at a customer location in the customer's data processing environment, often with customer-specific features and customizations, a consultant of the customer produces a prescriptive document for operating that database installation in that configuration. As another example, a self-help book on using that database product assumes a common configuration of the database, and provides or prescribes step-by-step instructions to cause the database to perform certain functions in that common configuration.

Furthermore, product documentation generally takes the form of a structured document that follows some defined structure, such as Darwin Information Typing Architecture (DITA). Unlike product documentation, prescriptive documentation is typically an unstructured document and can be in produced in a wide variety of forms, such as a white paper, a book, a blog post, an email, or even a collection of notes from several users, not counting dozens of other possible unstructured forms of capturing the prescriptive information.

As is often the case, product documentation is written such that the documentation applies to the product in all types of configurations anticipated by the manufacturer. A prescriptive document, on the other hand, satisfies a configuration-specific need for guidance in performing certain operations with the product. In some cases, a prescriptive document may cover some features of the product in great detail, such as with numerous use cases and notes; some features in a cursory manner, such as with just an example use case; and may not describe some features at all, such as those features that are either not installed or are not used in the given configuration.

Products migrate from version to version. For example, every so often, the manufacturer releases a new or updated version of the product. Along with the new release comes a new or updated version of the product documentation. Such product releases often cause the prescriptive documents to become out of date, out of sync, or otherwise incongruent with the new version of the product. If the new version is configured in an environment, the prescriptive documents must also be migrated to conform to the new version of the product.

Natural language processing (NLP) is a technique that facilitates exchange of information between humans and data processing systems. For example, one branch of NLP pertains to transforming human readable content into machine usable data. For example, NLP engines are presently usable to accept input content such as a newspaper article or a whitepaper, and produce structured data, such as an outline of the input content, most significant and least significant parts, a subject, a reference, dependencies within the content, and the like, from the given content.

Another branch of NLP pertains to answering questions about a subject matter based on information available about the subject matter domain.

Information about a domain can take many forms, including but not limited to knowledge repositories and ontologies. For example, domain-specific information can take the form of a list of words, phrases, and their equivalents as relate to a product.

Such information can be sourced from any number of data sources. The presenter of the information generally selects the form and content of the information. Before information can be used for NLP, generally, the information has to be transformed into a form that is usable by an NLP engine.

Shallow parsing is a term used to describe lexical parsing of a given content using NLP. For example, given a sentence, an NLP engine determining what the sentence semantically means according to the grammar of the language of the sentence is the process of lexical parsing, to wit, shallow parsing. In contrast, deep parsing is a process of recognizing the relationships, predicates, or dependencies, and thereby extracting new, hidden, indirect, or detailed structural information from distant content portions in a document.

### SUMMARY

The illustrative embodiments provide a method, system, and computer program product for migrating prescriptive content. An embodiment includes a method for logical migrating prescriptive content. The embodiment creates, at an application executing using a processor and a memory, using a natural language processing (NLP) engine, a first set of action objects from a first prescriptive document, the first prescriptive document relating to a first version of a product, wherein the prescriptive document comprises a description of a procedure for performing an operation on a specific configuration of the first version of the product. The embodiment creates, using the NLP engine, a second set of actions from a product documentation, the product documentation relating to a second version of the product, wherein the product documentation comprises a description of using a feature of the second version of the product. The embodiment maps, in a document, a first action object from the first set of action objects to a second action object from the second set of action objects, wherein the first action object is of a type that is described in the product documentation. The mapping includes substituting a first action of the first action object with a second action of the second action object. The mapping further includes replacing a property of the first action with a property of the second action. The mapping further includes populating the property of the second action with a value of the property of the first action.

Another embodiment includes a computer program product for logical migration of prescriptive content.

Another embodiment includes a computer system for logical migration of prescriptive content.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example parsing operation for migrating prescriptive content in accordance with an illustrative embodiment;

FIG. 4 depicts a block diagram of an example procedure in a prescriptive document and a transformation thereof in accordance with an illustrative embodiment;

FIG. 5 depicts a block diagram of another example parsing operation for migrating prescriptive content in accordance with an illustrative embodiment;

FIG. 6 depicts an example section of a product documentation that can be used in migrating prescriptive content in accordance with an illustrative embodiment;

FIG. 7 depicts a block diagram of an example feature in a product documentation and a transformation thereof in accordance with an illustrative embodiment;

FIG. 8 depicts a configuration or migrating prescriptive content in accordance with an illustrative embodiment;

FIG. 9 depicts a block diagram of an example process for generating a new prescriptive document from a modified structured document in accordance with an illustrative embodiment;

FIG. 10 depicts a block diagram of an example application for migrating prescriptive content in accordance with an illustrative embodiment; and

FIG. 11 depicts a flowchart of an example process for migrating prescriptive content in accordance with an illustrative embodiment.

### DETAILED DESCRIPTION

The illustrative embodiments recognize that updating a prescriptive document according to the changes in the updated version of the product is largely a manual task. Typically, presently, an author has to review a prescribed procedure in a prescriptive document, find the changes that affect the procedure in the product documentation, modify the procedure to incorporate those changes, and publish a revised version of the prescriptive document.

While an author updating his or her own prescriptive document is one use case for updating a prescriptive document, another commonly occurring use case is where the update performed is by a reader or user of the prescriptive document. In such cases, a reader or user comes across prescriptive documentation written for product version x but the user is using product version y. The user decides to modify the prescribed procedures by adding or incorporating a new or modified set of prescriptive instructions tailored to the product version the user is using. These modifications can take a user-specific form, as different from the form of the original prescriptive document.

As an extension of this use case, further assume that another user has further migrated to product version z. That user takes the modified prescriptive document from the user of version y and further modifies the document to suit version z. These modifications can take a user-specific form, as different from the user-specific form adopted by the user of version y, and further different from the form of the original prescriptive document.

The illustrative embodiments recognize that this manual process consumes significant resources such as personnel time, and is still quite error prone. For example, generally, given a product configuration, there can be numerous prescriptive documents. For example, for a database installation at a customer bank, the consumer accounts department may have a set of prescriptive documents, and the wealth management department may have a different set of prescriptive documents. Furthermore, the two departments may even use some common functions as “account review” implemented the database but in different manner, such as to obtain different views of the accounts.

Of course, a product documentation of the database product is not likely to have an “account review” section because that is a function specific to a configuration of product in a particular environment of the bank customer. Given this example, those of ordinary skill in the art will appreciate that a sizeable collection of prescriptive documents is possible relative to a single configuration of the product, and a much larger collection of prescriptive documents is generally present where multiple configurations of the product are concerned.

Therefore, the illustrative embodiments recognize that updating the prescriptive documents when an updated version of the product is configured can become a significant human undertaking that is not only expensive but also prone to human errors. The illustrative embodiments further recognize that product updates and version changes occur frequently, to apply patches, to correct errors, to keep up with an operating system or hardware architecture, to provide new or improved features, and for a variety of other reasons. Therefore, this presently manual process, which is already expensive and error prone, has to be performed repeatedly and frequently to ensure that the prescriptive documents corresponding to the product version are also up-to-date.

The illustrative embodiments used to describe the invention generally address and solve the above-described problems and other problems related to managing the prescriptive documents for a product. The illustrative embodiments provide a method, system, and computer program product for migrating prescriptive content.

An embodiment uses an NLP engine to parse, such as deep parse, a prescriptive document that corresponds to an outdated version of a product. The prescriptive document includes one or more prescriptive procedures in a human-readable form, to accomplish one or more tasks in a given configuration of a product. The human readable form of the contents of the prescriptive document may take the example forms including, but not limited to, free-form prose narrative, tabular text, instructions and steps, headings or sub-headings descriptive of the content or a part thereof, and references, such as to footnotes or other procedures in the given prescriptive document or another prescriptive document. The embodiment creates a structured document corresponding to the prescriptive document based on this NLP parsing.

For a procedure in the prescriptive document, the structured document comprises one or more data structures, which include discrete actions, operations, or instructions, and their corresponding parameters and parameter values, according to the procedure. For example, suppose that a procedure in the prescriptive document calls for entering a server name in a text field reached from the “file” menu by selecting the new” menu item followed y the “server” sub-menu item. The structured document according to the embodiment includes a data structure corresponding to the procedure.

The data structure includes as one object a “click” or “select” action that has a parameter or property of “menu” with a value of “file”. The data structure includes as another object a “click” or “select” action that has a parameter or property of “menu” with a value of “new”. The data structure includes as another object a “click” or “select” action that has a parameter or property of “menu” with a value of “server”. The data structure includes as one object a “type” or “enter” action that has a parameter or property of “server name text field” with a value of “server1”, assuming the prescriptive document instructs the user to name the server “server1”.

An embodiment further parses, for example, deep parses, a product documentation corresponding to the updated version of the product. Using the results of this parsing, the embodiment creates parsed product documentation. The parsed product documentation according to the embodiment includes one or more data structures containing structured information about the actions, operations, functions, or instructions relative to the updated version of the product as extracted from the product documentation.

For example, a data structure in the parsed product documentation may include as one object an action that has a parameter or property of “menu” with a value of “file”, another action object with a property of “menu” with a value of “new”, and another action object with property of “menu” and a value of “server profile”. The data structure may further include a “type” or “enter” action that has a parameter or property of “server profile name text field” with no suggested value.

A mapping rule is any suitable form of implementing logic, which, given one input from the structured document, produces one or more outputs from the parsed product documentation. An example mapping rule applicable to the above described example data structures may be that the “server” sub-menu item and the “server profile” sub-menu item are same or similar within a tolerance such that the “click” action with property of “menu” and value of “server” from the structured document can be mapped or translated to the action object with property of “menu” and a value of “server profile” from the parsed product documentation.

A tolerance used in mapping one part of a data structure from the structured document to a part of a data structure in the parsed product documentation comprises a value, a condition, or both. For example, one example tolerance provides that a first input string from the structured document has to match sixty percent or more of a second input string from the parsed product documentation, for the object containing the first string to be mapped to the object containing the second string. Other example tolerance provides that a first input property of type “text field” from the structured document can be matched to a second input property of type radio buttons from the parsed product documentation, for the object containing the first property to be mapped to the object containing the second property.

Product documentation often includes one or more sections where the changes in the features of the updated version are compared and summarized relative to the features of an older version of the product. For example, an older feature may have been removed and replaced, i.e., superseded by, with a different feature that performs the same or a similar function. As another example, an older feature may be falling out of favor or discouraged, also known as a deprecated feature, and the product documentation may recommend a different feature or combination of features to perform the operation of the deprecated feature. Some mapping rules, tolerances, or both, may result from parsing such a section of the product documentation.

These examples of data structures, objects, mappings, and tolerances are not intended to be limiting. From this disclosure, those of ordinary skill in the art will be able to conceive many other types, forms, and configurations of similar artifacts and the same are contemplated within the scope of the illustrative embodiments.

An embodiment further assigns a confidence value to a mapping. For example, if an object or a part thereof from the structured document exactly matches an object or a part thereof from the parsed product documentation, the embodiment may choose to assign a higher than threshold level of confidence to the mapping. As another example, if an object or a part thereof from the structured document matches an object or a part thereof from the parsed product documentation within a specified tolerance, the embodiment may choose to assign a higher than a second threshold level of confidence to the mapping. As another example, if an object or a part thereof from the structured document matches an object or a part thereof from the parsed product documentation, but the match is not exact and a tolerance is not specified for that mapping, the embodiment may choose to assign a lower than a threshold level of confidence to the mapping. As another example, if an object or a part thereof from the structured document matches an object or a part thereof from the parsed product documentation, but the match is based on a lexicographical match and not based on information derived from the product documentation, the embodiment may choose to assign a lower than a certain threshold level of confidence to the mapping.

A modified structured document contains the objects from the structured document that are modified using the objects in the parsed product documentation. For example, a first action object in a first structure in the structured document is mapped to a second action object from the parsed product documentation. A modified action object in the modified structured document comprises the second action object from the parsed product documentation occupying the position of the first action object in the first structure.

The property and property values associated with the first action are associated with the second action in the modified structured document. One embodiment further includes the confidence level attributed to the mapping relative to the second action in the structure in the modified structured document.

In some cases, a prescriptive document may include configuration-specific information embedded in a procedure. For example, the procedure may describe an exception that can occur in the customer's environment during the procedure. For example, during an account review procedure, an additional authentication window can pop-up requiring an additional input to verify the identity of the user performing the account review. Such a pop-up may not be a feature in the product in general, and may be triggered by a custom script configured with the product in the particular implementation in the customer's environment. Accordingly, the prescriptive document may include exception instructions to perform certain actions, such as input a user id and password in the pop-up to continue with another action in the procedure.

An embodiment recognizes an exception instruction or action in a procedure in the prescriptive document during the deep parsing of the prescriptive document. For example, the NLP engine recognizes the context of the description of the pop-up in the procedure as being configuration-specific by using surrounding information, such as headings or other indications. An embodiment uses such surrounding information revealed by the NLP deep parsing as metadata associated with the action. For example, in the case of the actions suggested in the procedure relative to the pop-up, the embodiment associates metadata tags “exception”, “custom”, “pop-up”, “authentication”, “additional input”, or some combination of these and other similarly purposed metadata tags with the action to provide input in the pop-up window.

Although mapping an exception action is likely in some cases, generally, an exception action may not be fit a suitable mapping rule. When an exception action is not mapped to any action from the parsed product documentation, an embodiment passes the exception action through from the structured document to the modified structured document without changing the contents or position of the exception action. A tolerance value may also not be applicable to an exception action, when the exception action is not mapped to any action from the parsed product documentation.

When the exception action can be mapped, an embodiment uses a mapping rule to map the exception action from the structured document to an action from the parsed product documentation, to populate a structure in the modified structured document. A tolerance value may be applicable to an exception action, when the exception action is mapped to an action from the parsed product documentation.

The association of metadata is not limited to exception actions only. Generally, any action can have associated therewith one or more metadata tags. Together with an action or an exception action in the structure in the modified structured document, an embodiment also includes the metadata tags, if any, that may be associated with the action.

An embodiment additionally flags a mapped action in the modified structured document when the confidence level of the mapping falls below a pre-determined threshold. The flag can be indicated in the structure in the modified structured document in any suitable manner, such as by setting a bit-flag or by using other similarly purposed parameter with the mapped action.

In some circumstances, the flag can be used to manually inspect the modified structured document, and modify or change the flagged mappings. For example, if a mapped action is flagged in the modified structured document, a user can change the mapped action by mapping the corresponding action from the structured document to a different action from the parsed product documentation, and reset the flag.

Finally, an embodiment produces a new prescriptive document from the modified structured document. The new prescriptive document includes a new structure corresponding to an old structure in the prescriptive document. The new structure includes the mapped actions and their corresponding properties and values from the modified structured document, arranged according to the arrangement of the actions in the old structure in the prescriptive document. The new structure also includes any exception actions that may be present in certain positions relative to the mapped actions in the modified structured document.

Where the properties of a mapped action do not exactly match the properties of the corresponding action in the old prescriptive document, the embodiment used the values of the properties that do match from the old prescriptive document in the new prescriptive document via the modified structured document. The embodiment either leaves the values of the non-matching properties blank or populates them according to the suggested values in the product documentation that have been carried through into the modified structured document during the mapping.

A method of an embodiment described herein, when implemented to execute on a device or data processing system, comprises substantial advancement of the functionality of that device or data processing system in producing accurate and updated prescriptive documents. For example, where prior-art requires each prescriptive document to be manually updated upon a product update, an embodiment automatically and reliably migrates the prescriptive documents using NLP analytics. Operating in a manner described herein, an embodiment significantly reduces the amount of effort required to migrate prescriptive documents and reduces the errors experienced in the prior-art prescriptive document migrations. Such manner of migrating prescriptive content is unavailable in presently available devices or data processing systems. Thus, a substantial advancement of such devices or data processing systems by executing a method of an embodiment facilitates migrating large sets of prescriptive documents while reducing cost and errors in data processing environments.

The illustrative embodiments are described with respect to certain products, procedures, prescriptive documents, products, product documentations, actions, properties, values, mappings, rules, tolerances, thresholds, confidence levels, flags, metadata tags, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

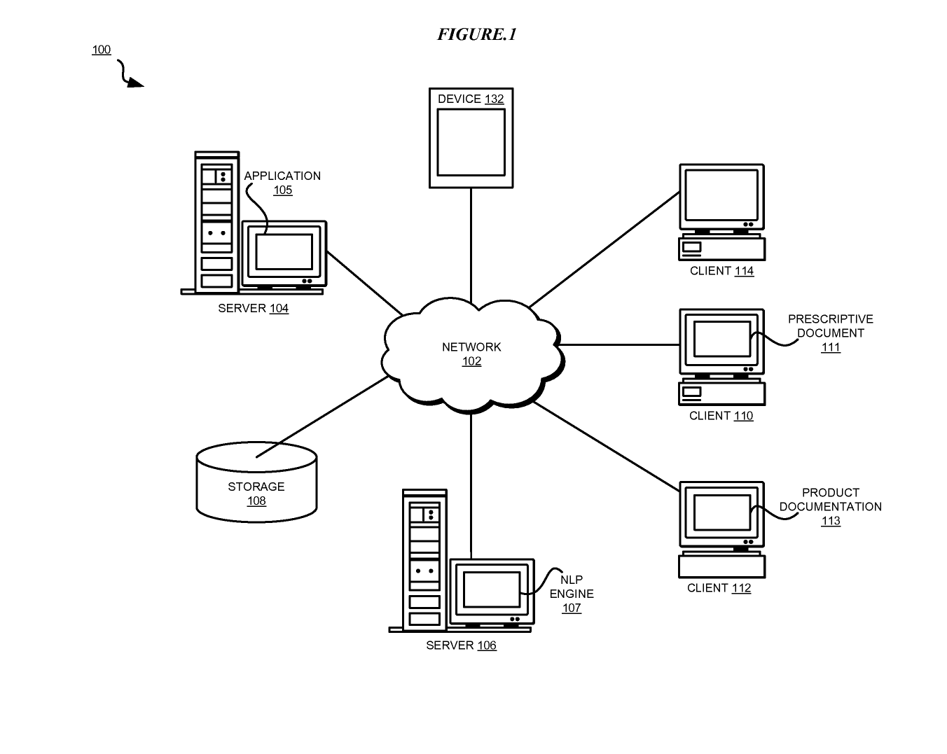

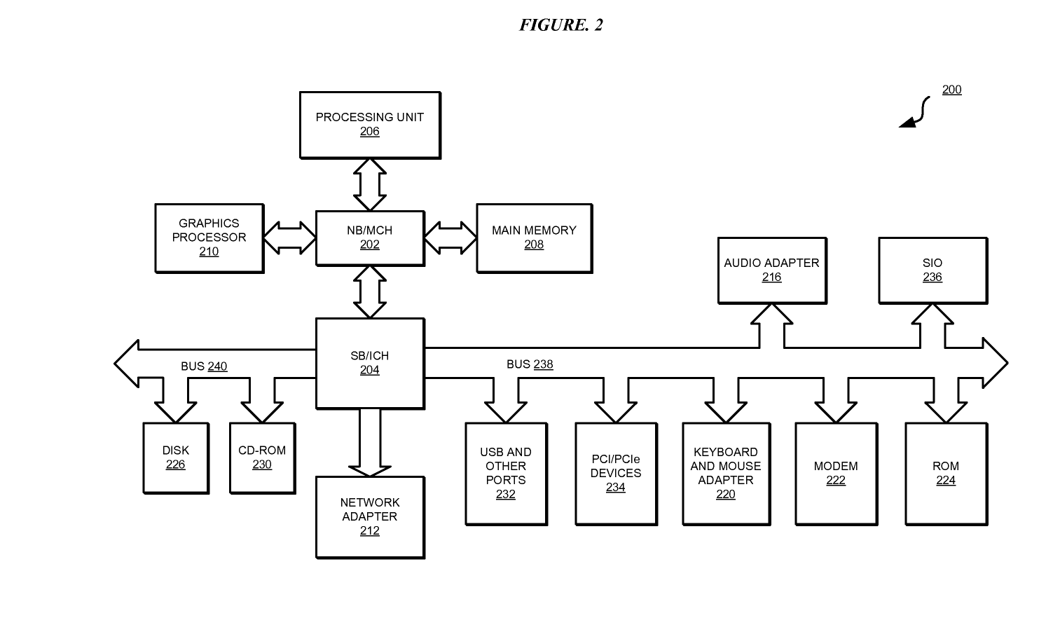

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device that can be configured for communicating over an overlay. Any software application described as executing in another data processing system in FIG. 1 can be configured to execute in device 132 in a similar manner. Any data or information stored or produced in another data processing system in FIG. 1 can be configured to be stored or produced in device 132 in a similar manner. Application 105 implements an embodiment described herein. Application 105 uses NLP engine 107 in server 106 to perform the parsing operations described herein using prescriptive document 111 and product documentation 113. Prescriptive document 111 is an old prescriptive document according to an old version of a product, and product documentation 113 is a new product documentation according to a new version of the product.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), Linux® (Linux is a trademark of Linus Torvalds in the United States and other countries), iOS™ (iOS is a trademark of Cisco Systems, Inc. licensed to Apple Inc. in the United States and in other countries), or Android™ (Android is a trademark of Google Inc., in the United States and in other countries). An object oriented programming system, such as the Java™ programming system, may run in conjunction with the operating system and provide calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as application 105 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

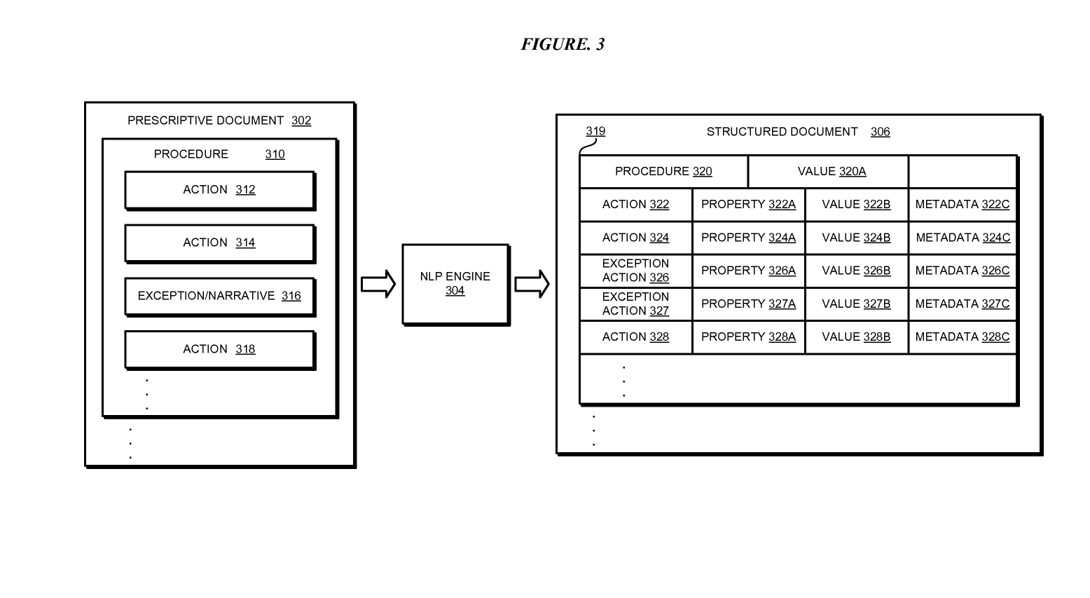

With reference to FIG. 3, this figure depicts a block diagram of an example parsing operation for migrating prescriptive content in accordance with an illustrative embodiment. Prescriptive document 302 is an example of prescriptive document 111 in FIG. 1. NLP engine 304 is an example of NLP engine 107 in FIG. 1. Structured document 306 is a result of the deep parsing performed by NLP engine 304 on prescriptive document 302.

Only as an example and without implying a limitation thereto, assume that prescriptive document 302 includes a description of procedure 310. Procedure 310 and the contents 312, 314, 316, and 318 thereof are depicted as blocks only for the clarity of the depiction and the description, and not to imply any structural organization of such contents within procedure 310. In fact, any or all of contents 312-318 can be unstructured text, e.g., prose narrative. Furthermore, any or all of contents 312-318 may not be positioned relative to one another as depicted, but may be scattered in different relative positions in prescriptive document 302 within the scope of the illustrative embodiments.

Content 312 describes an example action in procedure 310. The description of action 312 includes therewith a description of any associated properties and their corresponding values for procedure 310. Likewise, content 314 describes another example action in procedure 310. The description of action 314 may, but not necessarily, include therewith a description of any associated properties and their corresponding values for procedure 310.

Content 316 describes an exception. As described elsewhere in this disclosure, exception 316 is specific to a configuration of a product to which the prescriptive document 302 specifically pertains, as opposed to a product documentation of the product. In this example scenario, assume that the product documentation of the product does not contain an equivalence of exception 316 in describing an operation that is comparable to the operation performed in a part of procedure 310. As with action 314 or 316, the description of exception 316 may, but not necessarily, include therewith a description of any associated properties and their corresponding values for procedure 310.

Action 318 is another example action in procedure 310. The description of action 318 also may, but not necessarily, include therewith a description of any associated properties and their corresponding values for procedure 310.

Procedure 310 can include any number of actions and exceptions in this manner, and prescriptive document 302 can include any number of procedures in the manner of procedure 310. Operations described with respect to prescriptive document 302 can be performed with any number of prescriptive documents that are configured in the manner of prescriptive document 302.

NLP engine 304 forms structured document 306, particularly, structure 319, by performing deep parse on prescriptive document 302, such as, for example, to find relationships between procedure 310 and a distant description of action 314 elsewhere in prescriptive document 302. Procedure 320 in structure 319 is an object corresponding to procedure 310. NLP engine 304 extracts from parsing the description of procedure 310, value 320A corresponding to procedure object 320.

Similarly, by finding the association between action 312 and procedure 310, NLP engine 304 parses the description of action 312 to find action object 322. Action object 322 includes one or more property 322A and corresponding one or more value 322B. Zero or more metadata tags 322C in action object 322 are extracted from the description of action 312 as described elsewhere in this disclosure.

Action object 324 corresponds to action 314 in a similar manner. Action object 324 includes one or more property 324A with corresponding one or more value 324B, and zero or more metadata tags 324C.

Only for the purpose of thoroughness of the description of an operation of an embodiment, and without implying any limitation thereto, assume that exception 316 can be parsed into more than one exception actions. Generally, any number of exception actions are possible from exception 316 within the scope of the illustrative embodiments. Exception action object 326 is one such exception action that corresponds to exception 316. Exception action object 326 includes one or more property 326A with corresponding one or more value 326B, and zero or more metadata tags 326C. Exception action object 327 is another such exception action that corresponds to exception 316. Exception action object 327 includes one or more property 327A with corresponding one or more value 327B, and zero or more metadata tags 327C.

Action object 328 corresponds to action 318 in a similar manner. Action object 328 includes one or more property 328A with corresponding one or more value 328B, and zero or more metadata tags 328C.

Structured document 306 can include any number of structures similar to structure 319, and structure 319 can include any number of procedure objects 320 depending on the contents of prescriptive document 302. Structure 319 can further include any number of actions and exception actions in this manner.

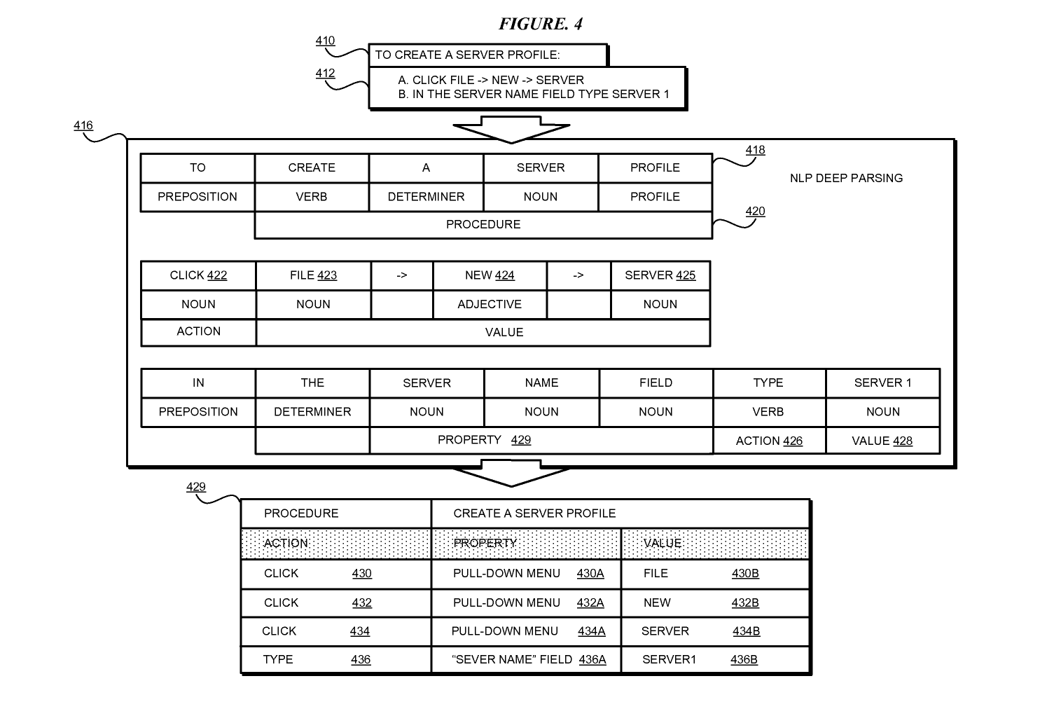

With reference to FIG. 4, this figure depicts a block diagram of an example procedure in a prescriptive document and a transformation thereof in accordance with an illustrative embodiment. The process described with respect to FIG. 3 is depicted in this figure to parse procedure 410 from a prescriptive document, such as from prescriptive document 302 in FIG. 3 using NLP engine 304 in FIG. 3.

Description 410 provides that a procedure to create a server profile is provided therein. Content 412 provides the actions to be performed under procedure 410. Description 410 corresponds to, and is an example of description 310 in FIG. 3. Content 412 corresponds to and is an example of some combination of actions in the manner of contents 312, 314, and 318 in FIG. 3. Only for the clarity of the example, no exceptions corresponding to exception 316 of FIG. 3 are described in FIG. 4.

NLP deep parsing by NLP engine 304 parses procedure 410 and contents 412 as shown in block 416. For example, from parsing description 410 into constituents 418, the NLP deep parsing determines that procedure 410 is described to “create” “a” “server” “profile”.

The NLP deep parsing further determines that in one portion of content 412, word 422 “click” forms one or more actions and has three values—value 423 “file”, value 424 “new”, and value 425 “server”. Given the context of procedure 420 from the prescriptive document, the NLP deep parsing determines that each of values 423, 424, and 425 are for properties “pull-down menu”. The NLP deep parsing also determines that in another portion of content 412, word 426 “type” forms another action, has property 427 “‘server’ ‘name’ ‘field’” and value 428 “server1”.

From the information parsed into block 416, the NLP engine outputs structure 429. Structure 429 is an example of structure 319 in FIG. 3. Structure 429 shows a procedure object with value “create a server profile”.

Structure 429 further includes actions 430, 432, 434, and 436. Action 430 corresponds to action 422 “click”, has property 430A “pull-down menu”, and value 430B “file” which corresponds to value 423. Similarly, action 432 corresponds to action 422 “click”, has property 432A “pull-down menu”, and value 432B “new” which corresponds to value 424. Action 434 corresponds to action 422 “click”, has property 434A “pull-down menu”, and value 434B “server” which corresponds to value 425. Action 436 corresponds to action 426 “type”, has property 436A “server name field” corresponding to property 427, and value 436B “server1” which corresponds to value 428.

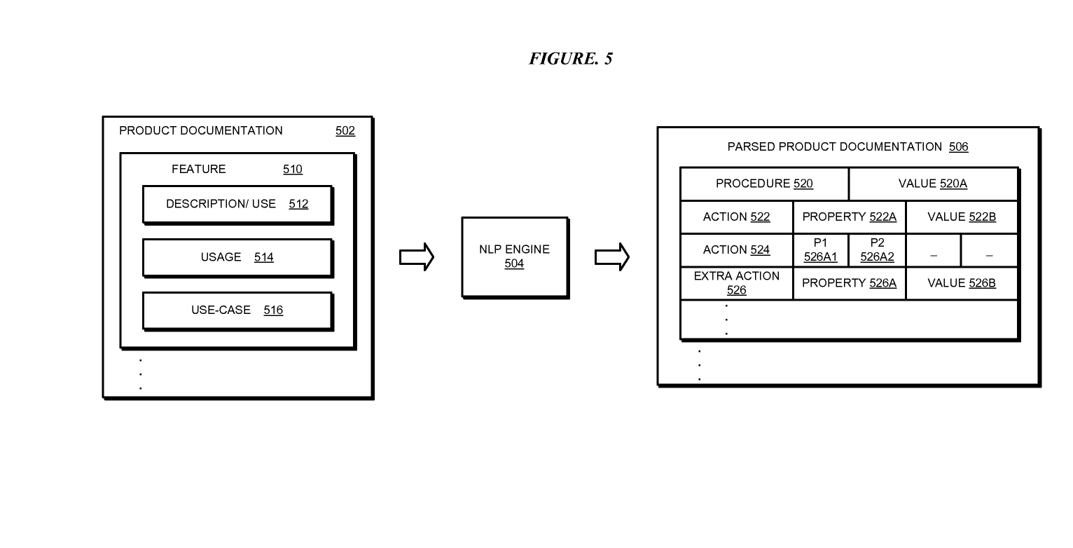

With reference to FIG. 5, this figure depicts a block diagram of another example parsing operation for migrating prescriptive content in accordance with an illustrative embodiment. Product documentation 502 is an example of product documentation 113 in FIG. 1. NLP engine 504 is an example of NLP engine 107 in FIG. 1. Parsed product documentation 506 is a result of the deep parsing performed by NLP engine 504 on product documentation 502.

Only as an example and without implying a limitation thereto, assume that product documentation 502 includes a section on feature 510 of a product. Feature 510 is described in product documentation 502 using description 512, manner of using or usage 514, and optionally use case 516. Contents 512, 514, and 516 under feature 510 thereof are depicted as blocks only for the clarity of the depiction and the description, and not to imply any structural organization of such contents within feature 510. In fact, any or all of contents 512-516 can be unstructured text, e.g., prose narrative. Furthermore, any or all of contents 512-518 may not be positioned relative to one another as depicted, but may be scattered in different relative positions in product documentation 502 within the scope of the illustrative embodiments.

Within contents 512-516 are described actions to perform in utilizing feature 510. The description of such one or more actions includes therewith a description of any associated properties and their corresponding values for such actions. Feature 510 can include any number of actions in this manner, and product documentation 502 can include any number of features in the manner of feature 510.

NLP engine 504 forms parsed product documentation 506, particularly, structure 519, by performing deep parse on product documentation 502. Procedure 520 in structure 519 is an object corresponding to feature 510. NLP engine 504 extracts from parsing the description of feature 510, value 520A corresponding to procedure object 520.

Similarly, NLP engine 504 parses the description of content 512-516 to find action objects 522, 524, and 526. Action object 522 includes property 522A and corresponding value 522B. As an example, action object 524 includes several properties—property 524A1 “P1” and property 524A2 “P2”. In this example, assume that product documentation 502 does not supply or recommend any specific values for properties P1 and P2 of action 524.

Action object 526 corresponds another action in feature 510. For use in an example described later, action 526 is labeled “extra action”. Extra action object 526 includes one or more property 526A with corresponding one or more value 526B.

Parsed product documentation 506 can include any number of structures similar to structure 519, and structure 519 can include any number of procedure objects 520 depending on the contents of product documentation 502. Structure 519 can further include any number of actions and extra actions in this manner.

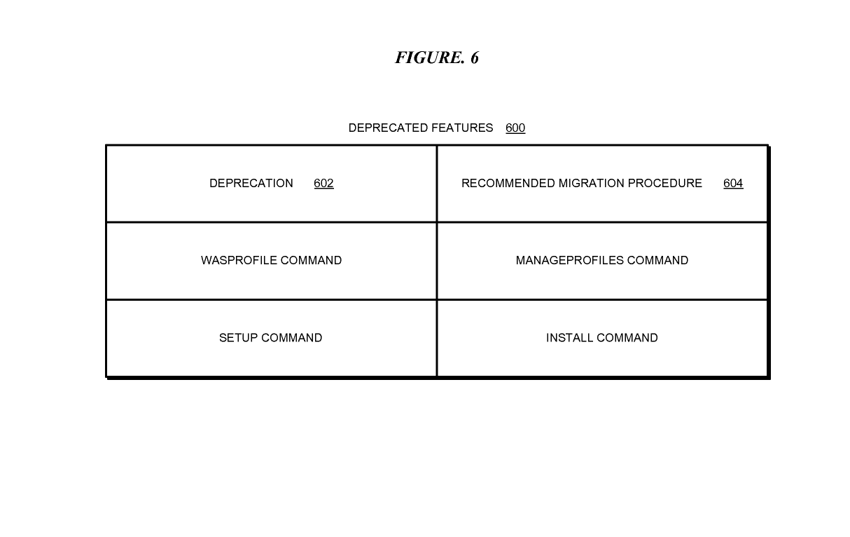

With reference to FIG. 6, this figure depicts an example section of a product documentation that can be used in migrating prescriptive content in accordance with an illustrative embodiment. Section 600 can be an example section in product documentation 502 in FIG. 5.

Section 600 lists one or more deprecated features of an older version of the product under example column 602. Column 604 provides a corresponding list of new features in a new version of the product of product documentation 502 as the recommended migration procedure for the deprecated features in column 602. For example, if the “wasprofile” command feature of an older version of the product was used for some operation, column 602 recommends that “manageprofiles” command feature be used instead for the same or similar operation with the new version of the product.

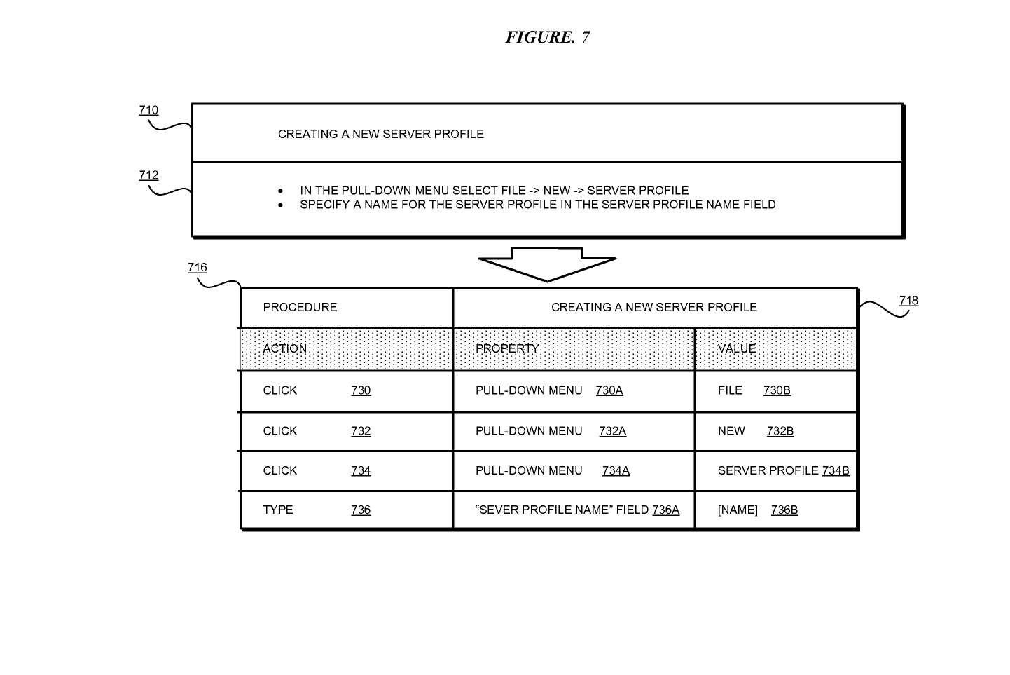

With reference to FIG. 7, this figure depicts a block diagram of an example feature in a product documentation and a transformation thereof in accordance with an illustrative embodiment. The process described with respect to FIG. 7 is depicted in this figure to parse feature 710 from a product documentation, such as from product documentation 502 in FIG. 5 using NLP engine 504 in FIG. 5.

Description 710 provides that a feature to create a server profile is provided therein. Content 712 provides the actions to be performed under feature 710. Description 710 corresponds to, and is an example of description 510 in FIG. 5. Content 712 corresponds to and is an example of some combination of contents 512, 514, and 516 in FIG. 5.

NLP deep parsing by NLP engine 504 parses feature 710 and contents 712 as shown in block 716. For example, from parsing description 710 into constituents 718, the NLP deep parsing determines that feature 710 describes a procedure for “creating” “a” “new” “server” “profile”.

In a parsing similar to the parsing described with respect to FIG. 4, the NLP deep parsing further determines that according to one portion of content 712, action 730 corresponds to action “click”, has property 730A “pull-down menu”, and value 730B “file”. Similarly, action 732 corresponds to action “click”, has property 732A “pull-down menu”, and value 732B “new”. Action 734 corresponds to action “click”, has property 734A “pull-down menu”, and value 734B “server profile”. Action 736 corresponds to action “type”, has property 736A “server profile name field”, and no value 736B “ ” where a user-supplied server name is to be provided.

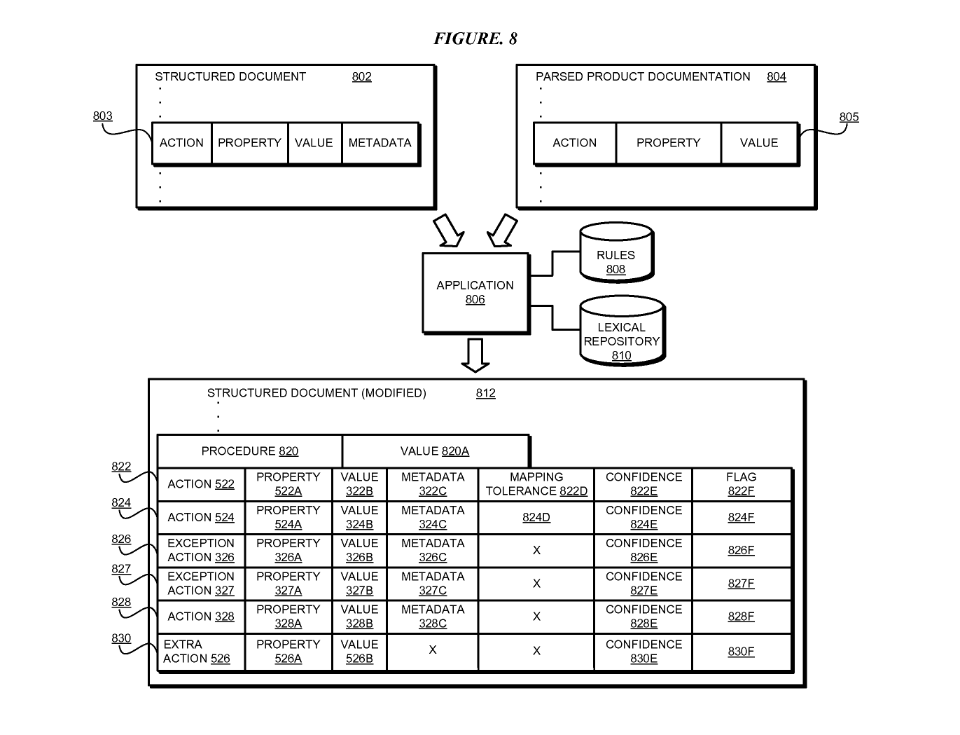

With reference to FIG. 8, this figure depicts a configuration or migrating prescriptive content in accordance with an illustrative embodiment. Structured document 802 is an example of structured document 306 in FIG. 3. Structured document 802 includes a set of objects 803, which includes objects such as action object 322, exception object 326, or some combination thereof. Parsed product documentation 804 is an example of parsed product documentation 506 in FIG. 5. Parsed product documentation 804 includes a set of objects 805, which includes objects such as action object 522, extra action object 526, or some combination thereof.

Application 806 is an example of application 105 in FIG. 1. Using mapping rules from rules repository 808, lexical repository 810, or a combination thereof, application 806 produces modified structured document 812 as described elsewhere in this disclosure. For example, procedure object 820 results from mapping procedure object 320 to procedure object 520. Value 820A is retained from value 320A.

Similarly, in object 822, application 806 maps action 322 from FIG. 3 to action 522 with property 522A from FIG. 5, while retaining value 322B in property 522A. Application 806 carries over metadata 322C from FIG. 3 in object 822. Optionally, any mapping tolerance applied in creating object 822 is listed as object property 822D. Optionally, in object property 822E, if application 806 assesses any confidence level according to a confidence rule in rules 808, that confidence level for the mapping of object 822 is listed in object property 822E. According to the confidence value in property 822E, flag 822F is set or reset. Flag 822F need not be a binary flag and can have more than two values. For example, flag 822F can be color coded, ranked from 0-n, and the like.

Object 824 similarly maps action 324 from FIG. 3 to action 524 with property 524A from FIG. 5, while retaining value 324B in property 524A. Application 806 carries over metadata 324C from FIG. 3 in object 824, and applies values to properties 824D, 824E, and 824F in a manner similar to object 822.

Exception action 326 has no mapping in a product documentation. Therefore, exception action 326 is carried over in object 826, in order with other mapped actions from structured document 306 such as after action 524. Object 826 carries over property 326A, value 326B, and metadata 326C from structured document 306. Mapping tolerance property does not apply to object 826 because exception action 326 has no mapping in a product documentation. Optionally, according to a confidence rule in rules 808, application 806 may assess a confidence level in carrying over exception action 326 as object 826. The confidence level or value, if assessed, is recorded in property 826E and flag 826F set accordingly.

Similarly, object 827 carries over property 327A, value 327B, and metadata 327C from structured document 306. Mapping tolerance property does not apply to object 827 because exception action 327 has no mapping in a product documentation. Optionally, according to a confidence rule in rules 808, application 806 may assess a confidence level in carrying over exception action 327 as object 827. The confidence level or value, if assessed, is recorded in property 827E and flag 827F set accordingly.

Object 828 finds no mapping for action 328 from FIG. 3 and therefore retains action 528 with property 328A and value 328B. Application 806 carries over metadata 328C from FIG. 3 in object 828. Mapping tolerance is not applicable due to absent mapping. Application 806 applies values to properties 828E and 828F in a manner similar to object 826, if applicable.

Extra action 526 has been added in the new product documentation. Therefore, extra action 526 is carried over in object 830, in order with other mapped actions from structured document 306 such as after action 328. Object 830 assigns property 526A value 526B. No metadata from a prescriptive document is available for extra action 526 and the mapping tolerance property does not apply to object 830 because no mapping is involved in object 830. Optionally, according to a confidence rule in rules 808, application 806 may assess a confidence level in carrying over extra action 526 as object 830. The confidence level or value, if assessed, is recorded in property 830E and flag 830F set accordingly.

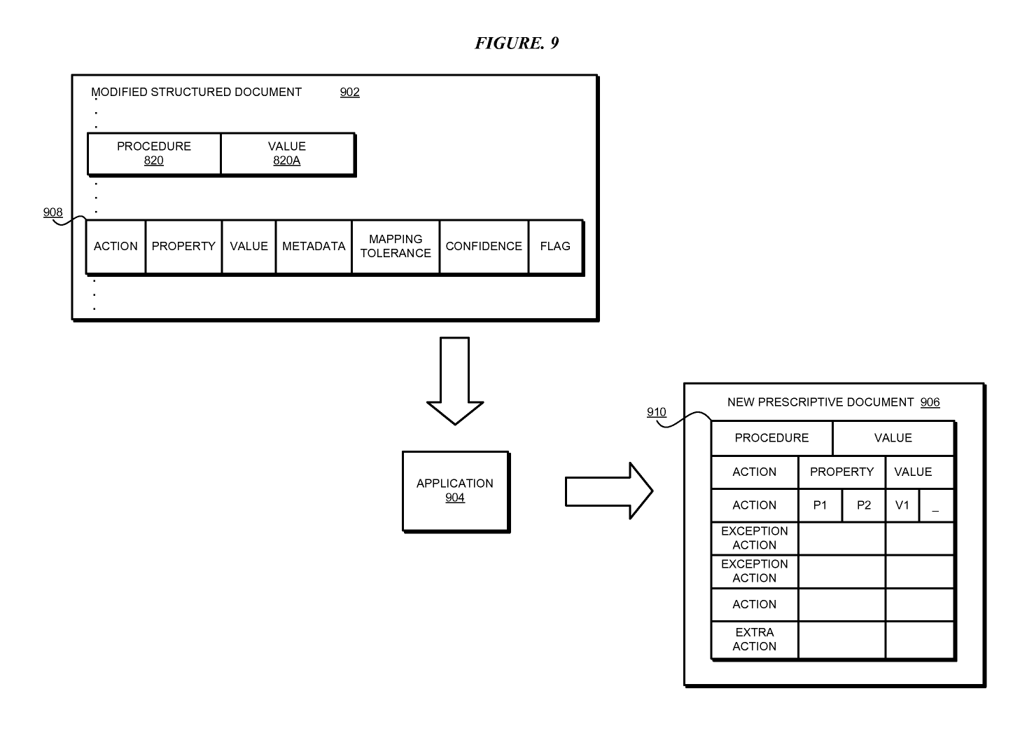

With reference to FIG. 9, this figure depicts a block diagram of an example process for generating a new prescriptive document from a modified structured document in accordance with an illustrative embodiment. Modified structured document 902 is an example of modified structured document 812 in FIG. 8. Application 904 is an example of application 806 in FIG. 8. Application 904 transforms modified structured document 902 into new prescriptive document 906.

Modified structured document 902 includes procedure object 820 with corresponding value 820A as in modified structured document 812 of FIG. 8. Modified structured document 902 further includes a set of objects 908 objects 822, 824, 826, 827, 828, and 830 from FIG. 8. In one embodiment, transforming modified structured document 902 into new prescriptive document 906 may simply remove extraneous properties such as the metadata, mapping tolerance, confidence level, and flag properties from the set of objects 908 to form structure 910 as shown in this figure.

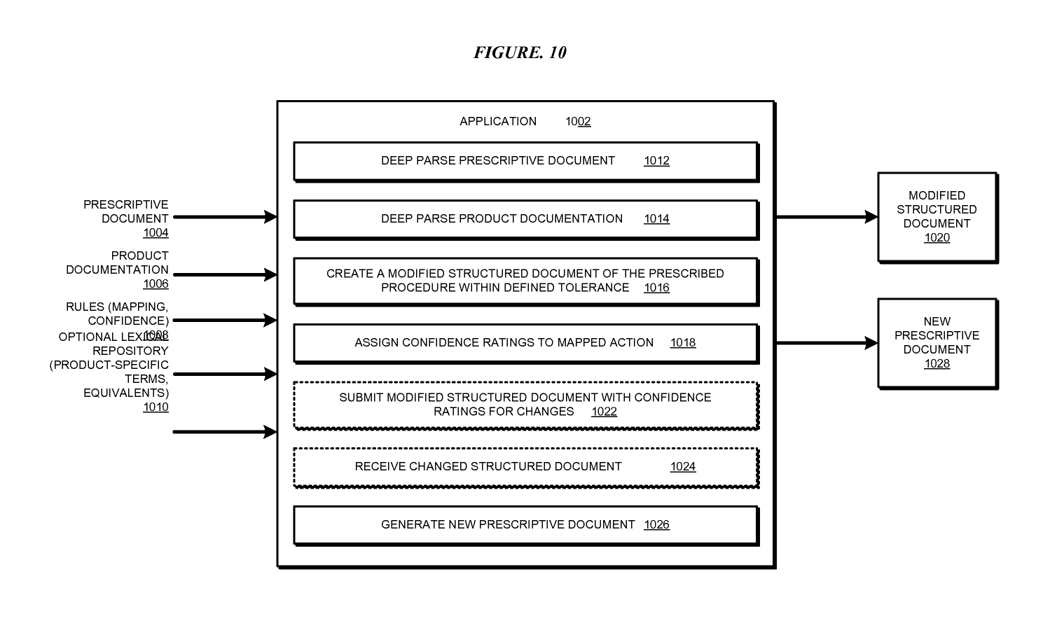

With reference to FIG. 10, this figure depicts a block diagram of an example application for migrating prescriptive content in accordance with an illustrative embodiment. Application 1002 can be implemented as application 904 in FIG. 9 or application 806 in FIG. 8.

Application 1002 accepts as input prescriptive document 1004, which is an example of prescriptive document 302. Product documentation 1006 is an example of product documentation 502 and forms another input to application 1002. Rules repository 1006 comprises a combination mapping rules and confidence rating rules. Rules repository 1006 is an example of rules repository 808 and forms another input to application 1002. Optional lexical repository 1010 comprises product-specific words, phrases and terms, and their equivalents. Lexical repository 1010 is an example of lexical repository 810.

Component 1012 uses an NLP engine (not shown) to deep parse prescriptive document 1004, as described with respect to FIG. 3. Component 1014 uses the NLP engine (not shown) to deep parse product documentation 1006, as described with respect to FIG. 5.

Component 1016 created a modified structured document from the structured document and the parsed product documentation within defined tolerances, using inputs 1008 and 1010, as described with respect to FIG. 8. Optionally, component 1018 assigns confidence ratings to one or more objects in the modified structured document as described with respect to FIG. 8. Resulting modified structured document 1020 is an example of modified structured document 812.

Optionally, component 1022 submits modified structured document 1020 for review and changes, such as by a human user, according to the confidence ratings, flag statuses, or some combination thereof. Component 1024 receives the changed document after the review. Component 1026 transforms modified structured document 1020 or the changed document, as the case may be, into new prescriptive document 1028. Application outputs new prescriptive document 1028 for use with the updated version of the product.

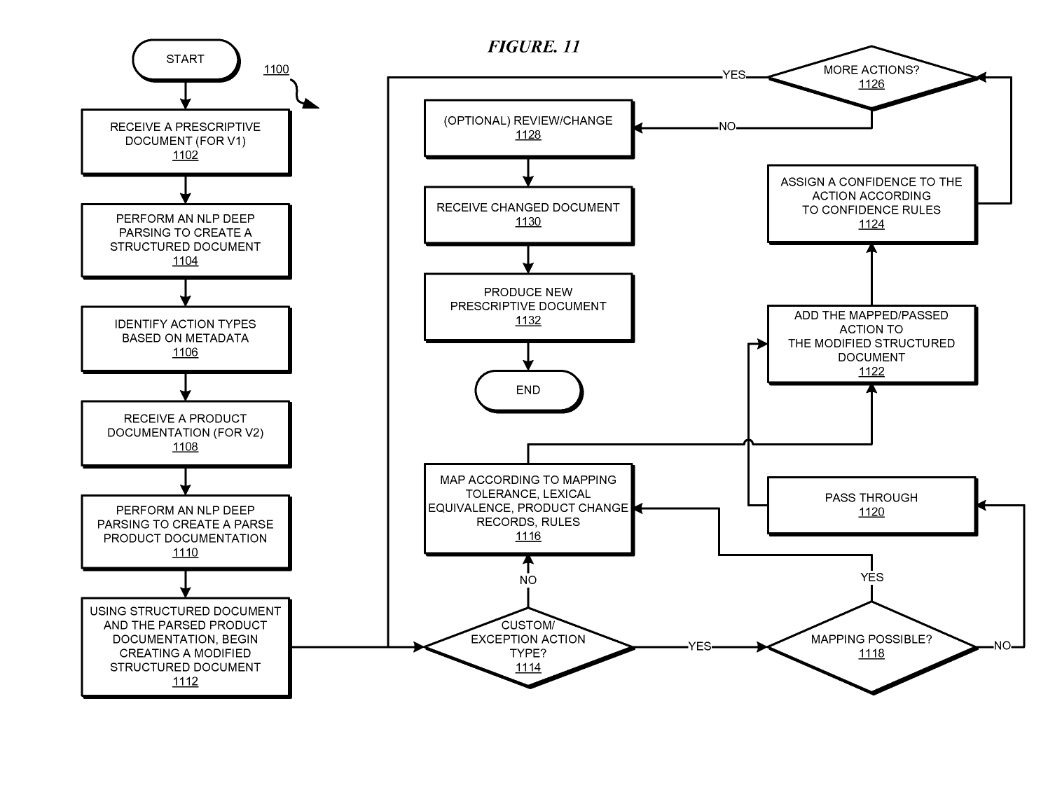

With reference to FIG. 11, this figure depicts a flowchart of an example process for migrating prescriptive content in accordance with an illustrative embodiment. Process 1100 can be implemented in application 1002 in FIG. 10.

The application receives a prescriptive document, e.g., for an old version of a product (block 1102). The application performs deep NLP parsing to create a structured document (block 1104). The application identifies action types based on metadata extracted from the prescriptive document (block 1106).

The application receives a product documentation, e.g., for a new version of the product (block 1108). The application performs deep NLP parsing on the product documentation to form a parsed product documentation (block 1110). The application uses the structured document and the parsed product documentation to begin creating a modified structured document (block 1112).

The application determines whether an action type of an action object in the structured document suggests that the action is configuration-specific, i.e., custom or exception type of action (block 1114). If the action type indicates that the action is not configuration-specific (“No” path of block 1114), the application maps the action object according to mapping tolerances, lexical equivalence, product change records such as in FIG. 6, rules, or some combination thereof (block 1116). The application then proceeds to block 1122.

If the action type indicates that the action is configuration-specific (“Yes” path of block 1114), the application determines whether the action can be mapped to an action in the product documentation (block 1118). If the action can be mapped (“Yes” path of block 1118), the application proceeds to block 1116. If the action cannot be mapped (“No” path of block 1118), the application passes the action through to the modified structured document (block 1120).

The application adds the mapped or passed action to the modified structured document (block 1122). Optionally, the application assigns a confidence level to the mapped or passed action according to a confidence rule (block 1124).

The application determines if more actions in the structured document are to be processed in this manner (block 1126). If more actions remain (“Yes” path of block 1126), the application returns to block 1114 and evaluates another action object from the structured document.

If no more actions remain (“No” path of block 1126), the application optionally submits the modified structured document for review or change, such as to a human user (block 1128). If submitted, the application receives the changed document from the reviewer (block 1130). The application produces the new prescriptive document by transforming the modified structured document or the changed document, as the case may be (block 1132). The application ends process 1100 thereafter.

Thus, a computer implemented method, system or apparatus, and computer program product are provided in the illustrative embodiments for migrating prescriptive content. Where an embodiment or a portion thereof is described with respect to a type of device, the computer implemented method, system or apparatus, the computer program product, or a portion thereof, are adapted or configured for use with a suitable and comparable manifestation of that type of device.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for logical migration of prescriptive content, the method comprising:
creating, at an application executing using a processor and a memory, using a natural language processing (NLP) engine, a first set of action objects from a first prescriptive document, the first prescriptive document relating to a first version of a product, wherein the prescriptive document comprises a description of a procedure for performing an operation on a specific configuration of the first version of the product;
creating, using the NLP engine, a second set of actions from a product documentation, the product documentation relating to a second version of the product, wherein the product documentation comprises a description of using a feature of the second version of the product; and
mapping, in a document, a first action object from the first set of action objects to a second action object from the second set of action objects, wherein the first action object is of a type that is described in the product documentation, the mapping comprising:
substituting a first action of the first action object with a second action of the second action object;
replacing a property of the first action with a property of the second action; and
populating the property of the second action with a value of the property of the first action.

2. The method of claim 1, further comprising:
comparing, as a part of the mapping, a first action corresponding to the first action object with a second action corresponding to the second action object, and wherein the substituting, the replacing, and the populating are each responsive to the comparing resulting the first action matching the second action within a tolerance.

3. The method of claim 1, further comprising:
using, in the document, a third action object from the first set of action objects, wherein the third action object is of a type that is not described in the product documentation.

4. The method of claim 3, wherein the third action object relates to the specific configuration of the first version of the product.

5. The method of claim 1, further comprising:
adding, in the document, a third action object from the second set of action objects, wherein the third action object is added in the product documentation for using the feature of the second version of the product.

6. The method of claim 1, further comprising:
adding relative to the second action object in the document, as a part of the mapping, a confidence level wherein the confidence level is indicative of a reliability of substituting the first action object with the second action object.

7. The method of claim 6, further comprising:
flagging the mapping using a flag in the document, responsive to the confidence level being below a threshold confidence level.

8. The method of claim 1, wherein the procedure comprises a set of actions, wherein the first set of action objects corresponds to the set of actions, and wherein the first action is a member of the set of actions.

9. The method of claim 1, wherein the feature comprises a set of actions, wherein the second set of action objects corresponds to the set of actions, and wherein the second action is a member of the set of actions.

10. The method of claim 1, wherein the method is embodied in a computer program product comprising one or more computer-readable storage devices and computer-readable program instructions which are stored on the one or more computer-readable tangible storage devices and executed by one or more processors.

11. The method of claim 1, wherein the method is embodied in a computer system comprising one or more processors, one or more computer-readable memories, one or more computer-readable storage devices and program instructions which are stored on the one or more computer-readable storage devices for execution by the one or more processors via the one or more memories and executed by the one or more processors.

12. A computer program product for logical migration of prescriptive content, the computer program product comprising:
one or more computer-readable tangible storage devices;
program instructions, stored on at least one of the one or more storage devices, to create, at an application executing using a processor and a memory, using a natural language processing (NLP) engine, a first set of action objects from a first prescriptive document, the first prescriptive document relating to a first version of a product, wherein the prescriptive document comprises a description of a procedure for performing an operation on a specific configuration of the first version of the product;
program instructions, stored on at least one of the one or more storage devices, to create, using the NLP engine, a second set of actions from a product documentation, the product documentation relating to a second version of the product, wherein the product documentation comprises a description of using a feature of the second version of the product; and
program instructions, stored on at least one of the one or more storage devices, to map, in a document, a first action object from the first set of action objects to a second action object from the second set of action objects, wherein the first action object is of a type that is described in the product documentation, the program instructions to map comprising:
program instructions, stored on at least one of the one or more storage devices, to substitute a first action of the first action object with a second action of the second action object;
program instructions, stored on at least one of the one or more storage devices, to replace a property of the first action with a property of the second action; and
program instructions, stored on at least one of the one or more storage devices, to populate the property of the second action with a value of the property of the first action.

13. The computer program product of claim 12, further comprising:
program instructions, stored on at least one of the one or more storage devices, to compare, as a part of the mapping, a first action corresponding to the first action object with a second action corresponding to the second action object, and wherein the substituting, the replacing, and the populating are each responsive to the comparing resulting the first action matching the second action within a tolerance.

14. The computer program product of claim 12, further comprising:
program instructions, stored on at least one of the one or more storage devices, to use, in the document, a third action object from the first set of action objects, wherein the third action object is of a type that is not described in the product documentation.

15. The computer program product of claim 14, wherein the third action object relates to the specific configuration of the first version of the product.

16. The computer program product of claim 12, further comprising:
program instructions, stored on at least one of the one or more storage devices, to add, in the document, a third action object from the second set of action objects, wherein the third action object is added in the product documentation for using the feature of the second version of the product.

17. The computer program product of claim 12, further comprising:
program instructions, stored on at least one of the one or more storage devices, to add relative to the second action object in the document, as a part of the mapping, a confidence level wherein the confidence level is indicative of a reliability of substituting the first action object with the second action object.

18. The computer program product of claim 17, further comprising:
program instructions, stored on at least one of the one or more storage devices, to flag the mapping using a flag in the document, responsive to the confidence level being below a threshold confidence level.

19. The computer program product of claim 12, wherein the procedure comprises a set of actions, wherein the first set of action objects corresponds to the set of actions, and wherein the first action is a member of the set of actions.

20. A computer system for logical migration of prescriptive content, the computer system comprising:
one or more processors, one or more computer-readable memories and one or more computer-readable storage devices;
program instructions, stored on at least one of the one or more storage devices for execution by at least one of the one or more processors via at least one of the one or more memories, to create, at an application executing using a processor and a memory, using a natural language processing (NLP) engine, a first set of action objects from a first prescriptive document, the first prescriptive document relating to a first version of a product, wherein the prescriptive document comprises a description of a procedure for performing an operation on a specific configuration of the first version of the product;
program instructions, stored on at least one of the one or more storage devices for execution by at least one of the one or more processors via at least one of the one or more memories, to create, using the NLP engine, a second set of actions from a product documentation, the product documentation relating to a second version of the product, wherein the product documentation comprises a description of using a feature of the second version of the product; and
program instructions, stored on at least one of the one or more storage devices for execution by at least one of the one or more processors via at least one of the one or more memories, to map, in a document, a first action object from the first set of action objects to a second action object from the second set of action objects, wherein the first action object is of a type that is described in the product documentation, the program instructions to map comprising:
program instructions, stored on at least one of the one or more storage devices for execution by at least one of the one or more processors via at least one of the one or more memories, to substitute a first action of the first action object with a second action of the second action object;
program instructions, stored on at least one of the one or more storage devices for execution by at least one of the one or more processors via at least one of the one or more memories, to replace a property of the first action with a property of the second action; and
program instructions, stored on at least one of the one or more storage devices for execution by at least one of the one or more processors via at least one of the one or more memories, to populate the property of the second action with a value of the property of the first action.
